(19) United States
(12) Patent Application Publication
(10) Pub. No.: US 2022/0317370 A1
(43) Pub. Date: Oct. 6, 2022

(54) THIN FILM OPTICAL WAVEGUIDE AND PREPARATION METHOD THEREFOR

(71) Applicant: IRIXI PHOTONICS (SUZHOU) CO., LTD., Suzhou (CN)

(72) Inventors: Yifan CHEN, Suzhou (CN); Meng HUANG, Suzhou (CN)

(21) Appl. No.: 17/608,132

(22) PCT Filed: Nov. 18, 2020
(86) PCT No.: PCT/CN2020/129677

§ 371 Date: Nov. 1, 2021

(30) Foreign Application Priority Data
Dec. 25, 2019 (CN) 2019 11358266.2

(51) Int. Cl. G02B 6/122; G02B 6/132

(52) U.S. Cl. CPC G02B 6/122; G02B 6/132; G02B 2006/12061

(57) ABSTRACT

A thin film optical waveguide includes a silicon-based substrate, a cladding layer arranged on the silicon-based substrate, and an optical waveguide core layer arranged on the silicon-based substrate. The optical waveguide core layer is arranged in the cladding layer, the optical waveguide core layer includes a double-layer optical waveguide dielectric thin film and a thin film material interlayer arranged between the double-layer optical waveguide dielectric thin film, the thin film material interlayer has a two-dimensional lattice sub-wavelength structure, and the effective lattice constant and the duty cycle of the two-dimensional lattice sub-waveguide structure have at least one numerical value in the same propagation direction. The thin film optical waveguide overcomes the limits of technology and materials, achieves a variable effective refractive index in same propagation direction, satisfies complex design and application scenarios, and reduces the difficulty of manufacturing the thin film optical waveguide having a variable effective refractive index.

### CROSS REFERENCE TO RELATED APPLICATIONS

This application claims priority of Chinese Patent Application No. 201911358266.2, filed Dec. 25, 2019, the entire disclosures of which are incorporated herein by reference.

### FIELD OF THE INVENTION

This application relates to a thin film optical waveguide and preparation method therefor.

### DESCRIPTION OF THE PRIOR ART

In the field of optical communications, optical waveguides are a necessary solid medium for transmitting high-speed optical signals. The optical waveguide is divided into a plurality of structures such as a planar type, a ridge type, a linear type and the like, can be used as a transmission medium of local or long-distance optical communication, and is also a basic component of optical devices such as a Mach-Zehnder interferometer, a wavelength division multiplexer, a micro-ring resonator etc. Single-mode optical waveguides are the fundamental mode of operation of most optoelectronic devices, particularly in the 1310 nm and 1550 nm optical communications wavelength ranges, and the single-mode of operation is generally determined by the structure and dimensions of the optical waveguide. The effective refractive index of the single-mode optical waveguide is one of important parameters for representing the performance of the single-mode optical waveguide in the design of an integrated optical circuit, and has a great influence on the performance of an overall optical device, so that the effective refractive index of the single-mode optical waveguide is an important index for determining the material and the structure of the optical waveguide. Thin film optical waveguides are widely used in the design of integrated optical circuits because of their high compatibility with modern semiconductor processes, typically using materials such as silicon, doped silica, lithium niobate etc. A sub-wavelength grating generally refers to a grating structure with a grating pitch much smaller than the wavelength of the propagating light, in which case diffraction of the light is suppressed, so that the structure can be equated with a uniform dielectric waveguide. Meanwhile, due to the additionally added two degrees of freedom (spacing and duty cycle), the structure of the sub-wavelength grating has higher design flexibility, and provides a design basis for the variable effective refractive index optical waveguide. The effective refractive index of the uniform dielectric optical waveguide using a single material or a composite structure is limited to a certain range, and continuous change of the effective refractive index within a certain range cannot be realized, and complicated design and use conditions cannot be necessarily satisfied.

### BRIEF SUMMARY OF THE INVENTION

The present invention aims to provide a thin film optical waveguide which has at least one numerical value of effective lattice constant and duty cycle of a two-dimensional lattice sub-wavelength structure in the same propagation direction so as to obtain an effective refractive index in the same propagation direction.

To achieve the above purposes, the present invention is realized as the follow technical solution:

a thin film optical waveguide, including a silicon-based substrate, a cladding layer arranged on the silicon-based substrate, and an optical waveguide core layer arranged on the silicon-based substrate, wherein the optical waveguide core layer is arranged in the cladding layer, the optical waveguide core layer comprises a double-layer optical waveguide dielectric thin film and a thin film material interlayer arranged between the double-layer optical waveguide dielectric thin film, the thin film material interlayer has a two-dimensional lattice sub-wavelength structure, and the effective lattice constant and the duty cycle of the two-dimensional lattice sub-waveguide structure have at least one numerical value in the same propagation direction.

Further, the effective lattice constant and the duty cycle of the two-dimensional lattice sub-wavelength structure have at least two continuously-changing numerical values in the same propagation direction.

Further, the two-dimensional lattice sub-wavelength structure comprises lattice points, and wherein the effective lattice constant and the duty cycle are determined by the shape, the length and the width of the lattice points.

Further, the lattice points are one of circular, elliptical, criss-cross, hexagonal, and octagonal.

Further, the two-dimensional lattice sub-wavelength structure is a Bravais lattice structure or a quasicrystal structure.

Further, the Bravais lattice structure is comprised of square or hexagon.

Further, the quasicrystal structure is comprised of octagon, decagon or dodecagon.

Further, the thin film material interlayer is one of silicon, doped silica, lithium niobate, titanium dioxide, zinc oxide, and magnesium doped zinc oxide.

Further, the optical waveguide dielectric thin film is doped silica.

Further, the doped silica is 2% germanium doped silica.

The invention also provides a preparation method of the thin film optical waveguide, and the preparation method is as follows:

S1, providing a silicon-based substrate, and forming a lower optical waveguide dielectric thin film on the silicon-based substrate;

S2, preparing the thin film material interlayer;

S3, preparing the thin film material interlayer into the two-dimensional lattice sub-wavelength structure, wherein the effective lattice constant and the duty cycle of the two-dimensional lattice sub-waveguide structure have at least one numerical value in the same propagation direction;

S4, preparing an upper layer optical waveguide dielectric thin film, wherein the lower layer optical waveguide dielectric thin film and the upper layer optical waveguide dielectric thin film form the double-layer optical waveguide dielectric thin film;

S5, preparing the cladding layer.

The beneficial effect of the present invention is: the effective lattice constant and the duty cycle of the two-dimensional lattice sub-wavelength structure of the thin film optical waveguide provided by the present invention have at least one numerical value in the same propagation direction, so that the effective refractive index of the thin film optical waveguide has at least one numerical value in the same propagation direction. The thin film optical waveguide overcomes the limits of technology and materials, achieves having a variable effective refractive index in the same propagation direction, satisfies complex design and application scenarios, and reduces the difficulty of manufacturing the thin film optical waveguide having a variable effective refractive index.

The above description is only an outline of the technical schemes of the present invention. Preferred embodiments of the present invention are provided below in conjunction with the attached drawings to enable one with ordinary skill in the art to better understand said and other objectives, features, and advantages of the present invention and to make the present invention accordingly.

### BRIEF DESCRIPTION OF THE DRAWINGS

FIG. 1 is a schematic structural diagram depicting the two-dimensional lattice sub-wavelength thin film optical waveguide according to an embodiment of the present invention.

FIG. 2 is a schematic structural view of the two-dimensional lattice sub-wavelength thin film optical waveguide of FIG. 1 in another direction.

FIG. 3 is a schematic structural diagram of another two-dimensional lattice sub-wavelength thin film optical waveguide in accordance with an embodiment of the present invention.

FIG. 4 is a graph of effective refractive index versus lattice constant for the thin film optical waveguide of FIG. 1.

FIG. 5 is a graph of effective refractive index versus duty cycle for the thin film optical waveguide of FIG. 1.

FIG. 6 is a graph of effective refractive index versus lattice constant and duty cycle for the thin film optical waveguide of FIG. 1.

FIG. 7 is a schematic view of a structure of a thin film optical waveguide having a continuously varying effective refractive index.

### DETAILED DESCRIPTION OF THE PREFERRED EMBODIMENTS

Specific embodiments of the present invention are described in further detail in combination with the related drawings and embodiments below. However, in addition to the descriptions given below, the present invention can be applied to other embodiments, and the scope of the present invention is not limited by such, rather by the scope of the claims.

In the description of the invention, it should be noted that the orientation or position relations indicated by the terms “center”, “up”, “down”, “left”, “right”, “vertical”, “horizontal”, “inside” and “outside” are based on the orientation or position relations shown in the attached drawings for the convenience of describing the invention and simplifying the description. Mechanisms or elements other than those indicated or implied must have, be constructed and operated in a particular orientation and shall not be construed as a limitation of the invention. In addition, the terms “first”, “second” and “third” are used for descriptive purposes only and are not to be understood to indicate or imply relative importance.

In the description of the invention, it should be noted that, unless otherwise expressly specified and qualified, the terms “mounting”, “connecting” and “connecting” should be understood in a broad sense, for example, a fixed connection, a detachable connection, or an integrated connection; It can be mechanical or electrical; It can be directly connected or indirectly connected through an intermediary. It can be connected within two components. For ordinary technicians in the field, the specific meanings of the above terms in the present invention can be understood on a case-by-case basis.

Furthermore, the technical features involved in the different embodiments of the invention described below may be combined with each other provided that they do not conflict with each other.

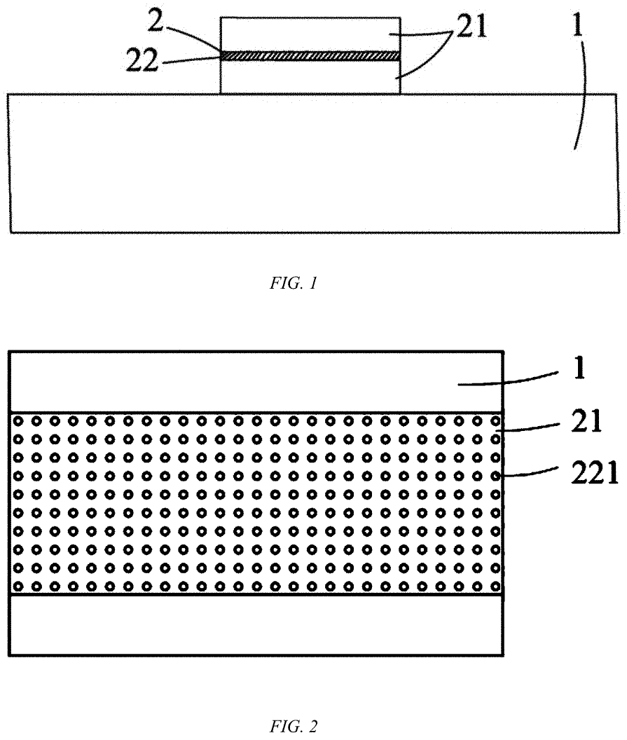

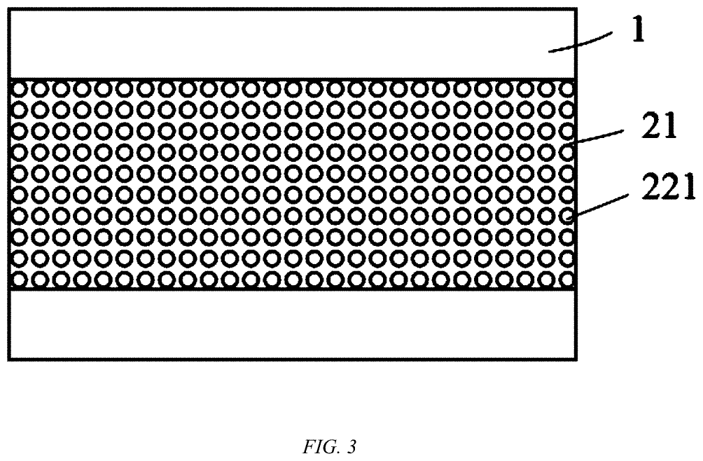

Referring to FIG. 1 and FIG. 3, the thin-film optical waveguide shown in an embodiment of the present invention includes a silicon-based substrate 1, an optical waveguide core layer 2 arranged on the silicon-based substrate 1, and a cladding layer (not shown) arranged on the silicon-based substrate 1. The optical waveguide core layer 2 is arranged in the cladding layer, and the refractive index of the optical waveguide core layer 2 is higher than that of the cladding layer. Specifically, the optical waveguide core layer 2 includes a double-layer optical waveguide dielectric thin film 21 with the same thickness and a thin film material interlayer 22 arranged between the double-layer optical waveguide dielectric thin film 21. The optical waveguide dielectric film 21 is typically doped silica. The thin film material interlayer 22 is generally one of common materials of silicon, doped silica and lithium niobate or negative thermal-optical coefficient materials of titanium dioxide, zinc oxide and magnesium-doped zinc oxide.

The thin-film material interlayer 22 is a two-dimensional lattice sub-wavelength structure, the effective lattice constant and the duty cycle of the two-dimensional lattice sub-wavelength structure have at least one numerical value in the same propagation direction, and the effective refractive index of the two-dimensional lattice sub-wavelength structure is determined by the effective lattice constant and the duty cycle, that is, the effective refractive index of the two-dimensional lattice sub-wavelength structure has at least one numerical value in the same propagation direction. Specifically, the effective lattice constants and the duty cycles of the two-dimensional lattice subwavelength structures at all positions in the same propagation direction are the same, but the effective lattice constants and the duty cycles are variable, as shown in FIGS. 2 and 3, the effective lattice constants and the duty cycles of the two thin film optical waveguides in the same propagation direction are different; in addition, the effective lattice constant and the duty cycle of the two-dimensional lattice subwavelength structure at different positions in the same propagation direction may be different, and the effective lattice constant and the duty cycle of the same two-dimensional lattice sub-wavelength structure in the same propagation direction may have two different values or more than two different values. The effective lattice constant and the duty cycle of the two-dimensional lattice sub-wavelength structure have at least two continuously-changing numerical values in the same propagation direction, that is, the effective refraction of the two-dimensional lattice sub-wavelength structure has at least two continuously-changing numerical values in the same propagation direction, and specifically, the effective lattice constant and the duty cycle of the same two-dimensional lattice sub-wavelength structure in the same propagation direction can change along with the movement of the position.

The two-dimensional lattice sub-wavelength structure includes lattice points 221, and the effective lattice constant and the duty cycle can be determined by the shape and length and width of the lattice points 221. The two-dimensional lattice sub-wavelength structure is a Bravais lattice structure or a quasi-lattice structure, the Bravais lattice comprises a square or a hexagon, and the quasi-lattice structure is an octagon or a decagon or a dodecagon. Referring to FIGS. 2 and 3, the two-dimensional lattice array is an abstract diagram, the lattice points 221 is the position of the centroid of the unit cell, the lattice constant A is the side length of the unit cell, and in FIGS. 2 and 3, the distance between two adjacent lattice points 221 can be considered. The lattice points 211 are one of circular, elliptical, criss-cross, hexagonal, and octagonal.

In this embodiment, the film optical waveguide includes a silica substrate 1, a double-layer optical waveguide dielectric film 21 of 2% germanium-doped silica, a titanium dioxide film material interlayer 22, and a silica cladding layer covering the double-layer optical waveguide dielectric film 21 and the film material interlayer 22, where the titanium dioxide film material interlayer 22 uses the two-dimensional lattice sub-wavelength structure of square Bravais lattice, and the lattice points 221 are circle.

Taking the film optical waveguide shown in this embodiment as an example, the wavelength of the incident light is selected to be 1550 nm, so as to describe in detail how to obtain that the effective lattice constant and the duty cycle of the two-dimensional lattice sub-wavelength structure have at least one value and at least two values that change continuously in the same propagation direction, so that the effective refractive index of the two-dimensional lattice sub-wavelength structure has at least one value and at least two values that change continuously in the same propagation direction. The optical waveguide medium film 21 in the thin film optical waveguide is a main optical waveguide structure, and ensures a single-mode working mode of the thin film optical waveguide. The two-dimensional lattice sub-wavelength structure formed in thin film material interlayer 22 can be considered as a single-mode optical waveguide structure of uniform dielectric. Therefore, the change of the effective refractive index of the two-dimensional lattice sub-wavelength structure can obtain the change of the effective refractive index of the thin film optical waveguide.

In the design of the thin film optical waveguide structure, this embodiment is guided by Scalar Heimholtz formula, that is:

∇²Ψ(x,y,z)+k₀²n²(x,y)Ψ(x,y,z)=0

Where, can be any field component, k₀ is the vacuum wave number, n is the refractive index, z direction is the propagation direction, x and y are the vertical and parallel directions of the cross section respectively. In order to obtain the solution of this formula, it can be simplified as follows by the effective refractive index method:

$$\frac{1}{F ( x , y )} \frac{{δ}^{2} F}{{δ x}^{2}} + {k}_{0}^{2} {n}^{2} ( x , y ) = {k}_{0}^{2} {n}_{eff}^{2} ( y )$$

$$\frac{1}{G ( y )} \frac{{d}^{2} G}{d {y}^{2}} - {β}^{2} = - {k}_{0}^{2} {n}_{eff}^{2} ( y )$$

Where, F and G are mode field distributions, n_{eff} is the effective refractive index, β is the propagation constant. The propagation constant and effective refractive index of the optical waveguide can be calculated by this method.

Since the effective lattice constant and the duty cycle are determined by the shape and the length and width of the lattice points 221, the effective lattice constant and the duty cycle of the lattice points 221 can be changed by adjusting the shape and the length and width of the lattice points 221. To ensure the mode of operation of a single mode optical waveguide, the lattice constant and duty cycle are selected to ensure that they are in the sub-wavelength domain.

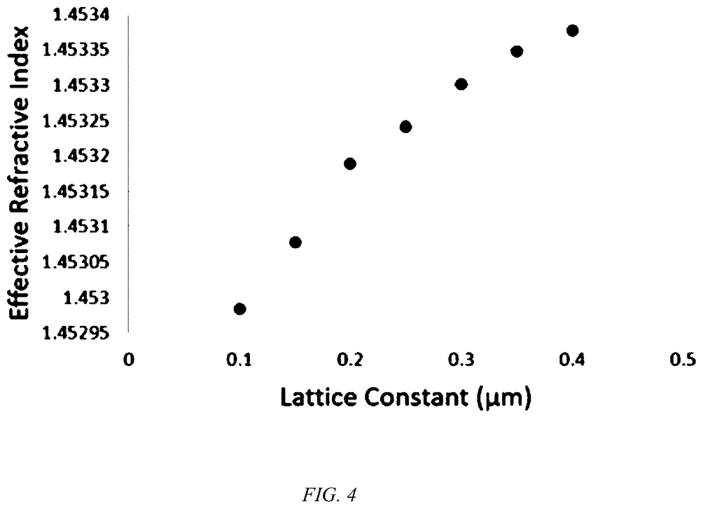

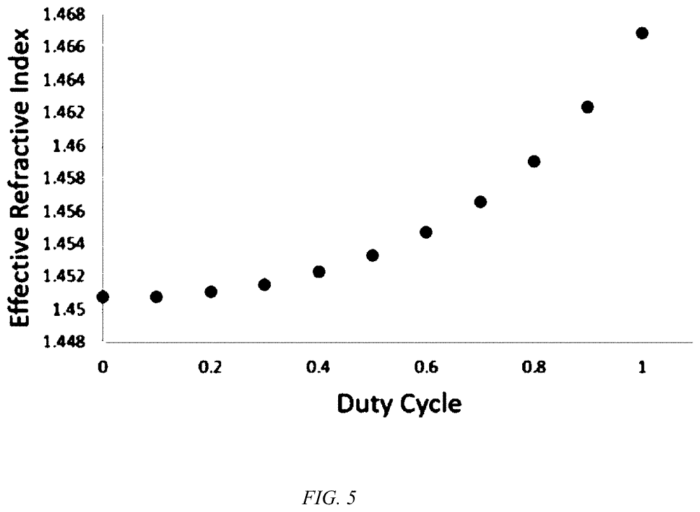

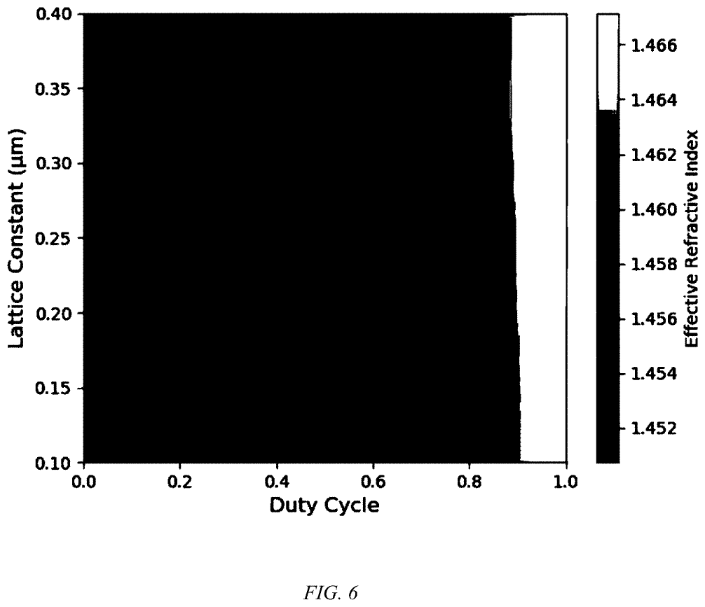

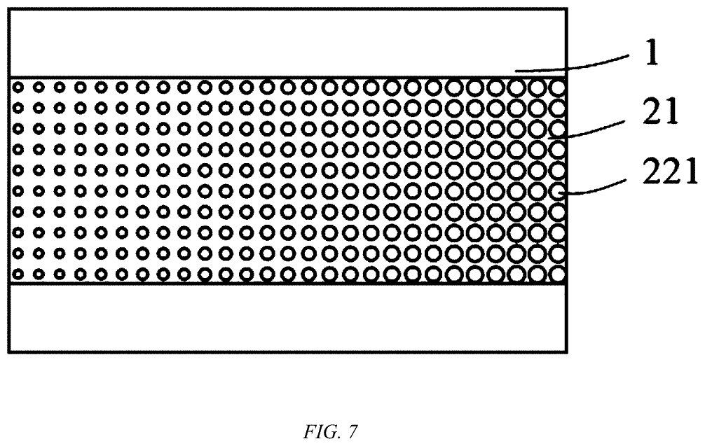

Referring to FIGS. 4 to 6, the effective refractive index of the thin film optical waveguide increases in a similar positive proportion to the increase of the lattice constant, and the effective refractive index increases in a similar exponential manner to the increase of the duty cycle. Therefore, in the process of manufacturing the thin film optical waveguide, due to the limitations of process precision and the like, the duty cycle of the thin film can be designed to determine the approximate interval of the effective refractive index, then the lattice constant is adjusted to reach a certain definite value, and the length and the width of the corresponding lattice points 221 are determined, so that the thin film optical waveguide having at least one numerical value effective refractive index in the same propagation direction is obtained. According to requirements, the method can be used for obtaining the thin film optical waveguide with variable effective refractive index in the same propagation direction or the thin film optical waveguide with different effective refractive index.

Referring to FIG. 7, by designing a continuously changing lattice constant or duty cycle of the titanium dioxide thin film interlayer 22 through simulation, and by manufacturing different lattice points 221, at least two values of the effective lattice constant and the duty cycle in the same propagation direction are obtained to be continuously changed. That is, a thin film optical waveguide having an effective refractive index continuously changing in the same propagation direction can be realized.

The invention obtains the effective lattice constant and the duty cycle which have at least one numerical value or at least two numerical values which are continuously changed in the same transmission direction by optimizing the length and the width of the lattice points in the two-dimensional lattice on the same thin film, and the effective refractive index of the light in the same transmission direction has at least one numerical value or at least two numerical values which are continuously changed at the moment, thereby obtaining the thin film optical waveguide with the variable or gradually-changing effective refractive index. The method can be applied to thin film optical waveguides formed in any two-dimensional lattice structure (hexagon, octagon, decagon, dodecagon, etc.) and associated lattice points (hexagon, octagon, decagon, dodecagon, etc.) shape.

The invention also provides a preparation method for preparing the thin film optical waveguide, and the preparation method is as follows:

S1, providing the silicon-based substrate 1, specifically silica substrate 1, coating the doped silica on the silica substrate 1 by PECVD (Plasma Enhanced Chemical Vapor Deposition) to form a lower optical waveguide dielectric thin film, in which the doped silica material is 2% germanium doped silica;

S2, preparing the thin film material interlayer 22 with titanium dioxide material by ALD (Atomic Layer Deposition);

S3, making the titanium dioxide thin film material interlayer into the two-dimensional lattice sub-wavelength structure by NIL (Nanoimprint Lithography) or electronbeam lithography or optical lithography, wherein, the effective lattice constant and the duty cycle of the two-dimensional lattice sub-wavelength structure are determined according to the required effective refractive index;

S4, coating 2% germanium doped silica material by PECVD to prepare the upper optical waveguide dielectric thin film, the lower optical waveguide dielectric thin film and the upper optical waveguide dielectric thin film form the double-layer optical waveguide dielectric film 21;

S5, preparing a silica cladding layer on the outer circumference of the double-layer optical waveguide dielectric film 21 and the thin film material interlayer 22.

To sum up, the effective lattice constant and the duty cycle of the two-dimensional lattice sub-wavelength structure of the thin film optical waveguide provided by the present invention have at least one numerical value in the same propagation direction, so that the effective refractive index of the thin film optical waveguide has at least one numerical value in the same propagation direction. The thin film optical waveguide overcomes the limits of technology and materials, achieves having a variable effective refractive index in the same propagation direction, satisfies complex design and application scenarios, and reduces the difficulty of manufacturing the thin film optical waveguide having a variable effective refractive index.

The technical features of the above embodiments can be combined arbitrarily, in order to make the description concise, not all possible combinations of the technical features in the above embodiments are described. However, as long as there is no contradiction between the combination of these technical features, they shall be considered to be within the scope of this specification.

The present invention only described several above embodiments, which are described more specific and detailed, but it cannot be understood as a limitation on the scope of the present invention. It should be pointed out that for ordinary technical personnel in the art, without departing from the concept of the present invention, a number of deformation and improvements can be made, which belong to the scope of the present invention. Therefore, the scope of the present invention shall be subject to the recorded claims.

1. A thin film optical waveguide, including a silicon-based substrate and a cladding layer arranged on the silicon-based substrate, and is characterized by further including an optical waveguide core layer arranged on the silicon-based substrate, wherein the optical waveguide core layer is arranged in the cladding layer, the refractive index of the optical waveguide core layer is higher than that of the cladding layer, the optical waveguide core layer comprises a double-layer optical waveguide dielectric thin film and a thin film material interlayer arranged between the double-layer optical waveguide dielectric thin film, the thin film material interlayer has a two-dimensional lattice sub-wavelength structure, and the effective lattice constant and the duty cycle of the two-dimensional lattice sub-waveguide structure have at least one numerical value in the same propagation direction.

2. The thin film optical waveguide according to claim 1, characterized in that the effective lattice constant and the duty cycle of the two-dimensional lattice sub-wavelength structure have at least two continuously-changing numerical values in the same propagation direction.

3. The thin film optical waveguide according to claim 2, characterized in that the two-dimensional lattice sub-wavelength structure comprises lattice points, and wherein the effective lattice constant and the duty cycle are determined by the shape, the length and the width of the lattice points.

4. The thin film optical waveguide according to claim 3, characterized in that the lattice points are one of circular, elliptical, criss-cross, hexagonal, and octagonal.

5. The thin film optical waveguide according to claim 1, characterized in that the two-dimensional lattice sub-wavelength structure is a Bravais lattice structure or a quasicrystal structure.

6. The thin film optical waveguide according to claim 5, characterized in that the Bravais lattice structure is comprised of square or hexagon.

7. The thin film optical waveguide according to claim 5, characterized in that the quasicrystal structure is comprised of octagon, decagon or dodecagon.

8. The thin film optical waveguide according to claim 1, characterized in that the thin film material interlayer is one of silicon, doped silica, lithium niobate, titanium dioxide, zinc oxide, and magnesium doped zinc oxide.

9. The thin film optical waveguide according to claim 1, characterized in that the optical waveguide dielectric thin film is doped silica.

10. The thin film optical waveguide according to claim 9, characterized in that the doped silica is 2% germanium doped silica.

11. A preparation method of the thin film optical waveguide according to claim 1, characterized in that the preparation method is as follows:
S1, providing a silicon-based substrate, and forming a lower optical waveguide dielectric thin film on the silicon-based substrate;
S2, preparing the thin film material interlayer;
S3, preparing the thin film material interlayer into the two-dimensional lattice sub-wavelength structure, wherein the effective lattice constant and the duty cycle of the two-dimensional lattice sub-waveguide structure have at least one numerical value in the same propagation direction;
S4, preparing an upper layer optical waveguide dielectric thin film, wherein the lower layer optical waveguide dielectric thin film and the upper layer optical waveguide dielectric thin film form the double-layer optical waveguide dielectric thin film;
S5, preparing the cladding layer.
